(19) United States
(12) Patent Application Publication
(10) Pub. No.: US 2012/0125096 A1
(43) Pub. Date: May 24, 2012

(54) INERTIAL SENSOR

(75) Inventors: Heung Woo Park, Gyunggi-do (KR); Won Kyu Jeung, Seoul (KR); Hyun Kee Lee, Gyunggi-do (KR); Si Joong Yang, Gyunggi-do (KR)

(73) Assignee: SAMSUNG ELECTRO-MECHANICS CO., LTD., Gyunggi-do (KR)

(21) Appl. No.: 13/283,517

(22) Filed: Oct. 27, 2011

(30) Foreign Application Priority Data
Nov. 18, 2010 (KR) 1020100115015

(51) Int. Cl. G01C 19/56

(52) U.S. Cl. 73/504.12

(57) ABSTRACT

Disclosed herein is an inertial sensor which includes a sensing unit including a mass mounted to be displaced on a flexible substrate part, a driving unit moving the mass, and a displacement detecting unit detecting a displacement of the mass, the inertial sensor comprising: a top cap covering a top of the flexible substrate part; and a bottom cap covering a bottom of the mass. Thereby, the inertial sensor can be implemented in an economic EMC molding package shape, while protecting the mass and the piezo-electric element. Further, the inertial sensor optimizes a thickness of the cap covering the mass and the piezo-electric element and an interval between the mass and the piezo-electric element to have improved freedom in design of space utilization as well as improved driving characteristics and Q values.

### CROSS REFERENCE TO RELATED APPLICATION

This application claims the benefit of Korean Patent Application No. 10-2010-0115015, filed on Nov. 18, 2010, entitled “Inertial Sensor”, which is hereby incorporated by reference in its entirety into this application.

### BACKGROUND OF THE INVENTION

1. Technical Field

The present invention relates to an inertial sensor.

2. Description of the Related Art

An inertial sensor measuring physical quantity of acceleration and/or angular velocity has been widely used when mounted on a cellular phone, a game machine, a motion remote controller of a digital TV, a remote controller of the game machine, and a sensor module which is capable of sensing hand shake, positions and angles of motion.

The inertial sensor senses motion as acceleration or angular velocity information and converts the acceleration or angular velocity information into electrical signals to operate equipment based on the input of the motion of a user, thereby being implemented as a motion interface. The inertial sensor is broadly used such as for navigation, control, or the like of an airplane, a vehicle, in addition to the motion sensor and the like of home appliances.

In addition, as the inertial sensor is applied to a portable PDA, a digital camera, a cellular phone, or the like, a need exists for a technology into a smaller and lighter product having various functions, and as a result, there is a demand for a development of a micro sensor module.

An inertial sensor, which is implemented as an economic micro-size used for home appliances and personal portable equipment, mainly uses a capacitive scheme and a piezo-electric scheme. A driving unit of the inertial sensor may be classified into a piezo-electric driving scheme and a capacitive driving scheme, and a sensing unit thereof may also be classified into a piezo-electric sensing scheme, a capacitive sensing scheme, and a piezoresistive sensing scheme.

The piezo-electric driving scheme uses a reverse piezo-electric effect in which deformation is generated when AC voltage is applied to a piezoelectric material, and the piezo-electric sensing scheme uses a direct piezo-electric effect in which charges are formed when stress is applied to a piezoelectric material. For example, U.S. Pat. No. 5,646,346 discloses an angular velocity sensor which uses a piezoelectric element formed on a plate-shaped flexible portion as a driving unit and a sensing unit.

On the other hand, the capacitive driving scheme allows two electrodes to be opposite to each other in a short distance and vibrates a mass when AC voltage is applied between the two electrodes, and the capacitive sensing scheme detects a voltage generated due to a relative displacement between the two electrodes. For example, U.S. Pat. No. 6,003,371 discloses an angular velocity sensor which uses a capacitive element configured of an electrode formed on a driving body or a plate-shaped flexible portion and a fixed electrode as a driving unit and a sensing unit.

In addition, a method of forming a comb-shaped electrode for improving sensitivity to increase an area of the electrode has been widely used. The piezoresistive sensing scheme uses a piezoresistive effect in which a resistance value is changed according to the deformation. Japanese Patent No. 3171970 discloses an angular velocity sensor which uses a piezoresistive element formed on a plurality of beam-shaped flexible portions as a sensing unit of deformation of the flexible portions.

When the driving or the sensing is performed using the capacitive scheme, a method of changing a resonant frequency of a driving mode or a sensing mode equivalent to the electrostaticforce generated by applying DC bias voltage to a capacitive element to control Δf has been publicly known in a plurality of references including the cited reference entitled: “A Micro Machined Vibrating Rate Gyroscope with Independent Beams for the Driving and Detection Modes”. However, the method requires a high voltage and increases power consumption, such that it is not appropriate for mobile equipment.

When the driving or the sensing is performed using the piezo-electric scheme, great sensitivity of the angular velocity sensor can be obtained by a high electro mechanical coupling coefficient of the piezo-electric effect.

More specifically, the piezo-electric element for implementing the inertial sensor has characteristics that deformation is generated when voltage is applied and charges are generated when force is applied from the outside, such that it has been mainly used in various actuators, sensor, and the like.

As the piezo-electric element, various materials such as Aln, ZnO, quartz, and the like are used; however, PZT having a large piezo-electric constant has been mainly used in various fields. The piezo-electric element should be generally subjected to a poling step before being operated after the element is manufactured, in order to improve the characteristics. The piezo-electric characteristics are improved during a process of applying temperature and voltage.

The method using the piezo-electric element can be implemented as an atmospheric packaging without a vacuum packaging, as compared to the capacitive scheme. The economic micro-size piezo-electric inertial sensor, manufactured by a bulk micro-machining technology having a silicon structure, includes a circular plate-shaped spring having a cylindrical silicon mass provided in the center thereof, wherein the mass is driven right and left/back and forth or a complex direction thereof according to an applied driving voltage.

As the method of packaging the economic micro-size piezo-electric inertial sensor, a QFN or LGA packaging is mainly used and to this end, the inertial sensor is subjected to an EMC molding process. In the EMC molding process, the silicon structure element is mounted in a lead frame or flexible substrate and all the surroundings of the element are filled with epoxy.

In the EMC molding process, the mass, which is the micro mass, should be protected and to this end, a need exists for a structure that protects the mass from the EMC epoxy or external environment. However, the piezo-electric inertial sensor according to the prior art uses a plastic leaded chip carrier (PLCC) package shape or a ceramic leadless chip carrier (CLCC) package shape both having an internal space empty therein and a cap covering thereof, for example, a box, such that it cannot be implemented as an economic micro-size EMC molding package shape.

### SUMMARY OF THE INVENTION

The present invention has been made in an effort to provide an inertial sensor that includes a top cap and a bottom cap covering a mass and a piezo-electric element of the inertial sensor to be implemented in an economic EMC molding package shape, while protecting the mass and the piezo-electric element.

In addition, the present invention has been made in an effort to provide an inertial sensor that optimizes a thickness of the cap covering the mass and the piezo-electric element and an interval between the mass and the piezo-electric element to have improved freedom in design of utilizing space as well as improved driving characteristics and Q values.

According to a preferred embodiment of the present invention, there is provided an inertial sensor which includes a sensing unit including a mass mounted to be displaced on a flexible substrate part, a driving unit moving the mass, and a displacement detecting unit detecting a displacement of the mass, the inertial sensor including: a top cap covering a top of the flexible substrate part; and a bottom cap covering a bottom of the mass.

The top cap and the bottom cap may have a thickness of 100 to 200 μm, respectively.

When the top cap and the bottom cap are each formed of a 4-inch substrate, they may have a thickness of 100 μm, when the top cap and the bottom cap are each formed of a 6 to 8-inch substrate, they may have a thickness of 120 to 150 μm, and when the top cap and the bottom cap are each formed of a 12-inch substrate, they may have a thickness of 150 to 200 μm.

The top cap may have an etching part formed at an edge portion thereof, wherein the etching part is subjected to an anisotropic dry etching process using fluorine or chlorine, and alternatively, the top cap may have an etching part formed at an edge portion thereof, wherein the etching part is subjected to an anisotropic wet etching process using TMAH or KOH.

The top cap and the bottom cap may be made of silicon or Pyrex glass.

The sensing unit may further include a support supporting the flexible substrate part and the mass.

The top cap and the bottom cap may be thinned and then bonded to a top of the flexible substrate part and a bottom of the support, respectively.

A cavity may be formed between the top cap and the flexible substrate part and between a mass and the bottom cap, respectively, and the cavity may have a height of 20 to 100 μm.

The top cap and the bottom cap may be each bonded to the top of the flexible substrate part and the bottom of the support by wafer level bonding or bonding using adhesive.

The inertial sensor as set forth may further include: an ASIC chip coupled to the bottom of the sensing unit; a lead frame or a flexible substrate coupled to the bottom of the ASIC chip; and a wire connecting between the sensing unit and the ASIC chip and between the ASIC chip and the lead frame or the flexible substrate, respectively.

### BRIEF DESCRIPTION OF THE DRAWINGS

FIG. 1 is a schematic cross-sectional view of an inertial sensor according to a first preferred embodiment of the present invention;

FIG. 2 is a schematic cross-sectional view of a sensing unit of an inertial sensor according to a second preferred embodiment of the present invention;

FIG. 3 is a schematic cross-sectional view of a sensing unit of an inertial sensor according to a third preferred embodiment of the present invention; and

FIG. 4 is a schematic cross-sectional view of a sensing unit of an inertial sensor according to a fourth preferred embodiment of the present invention.

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, a detailed description thereof will be omitted.

Hereinafter, an inertial sensor according to preferred embodiments of the present invention will be described in detail with reference to the accompanying drawings.

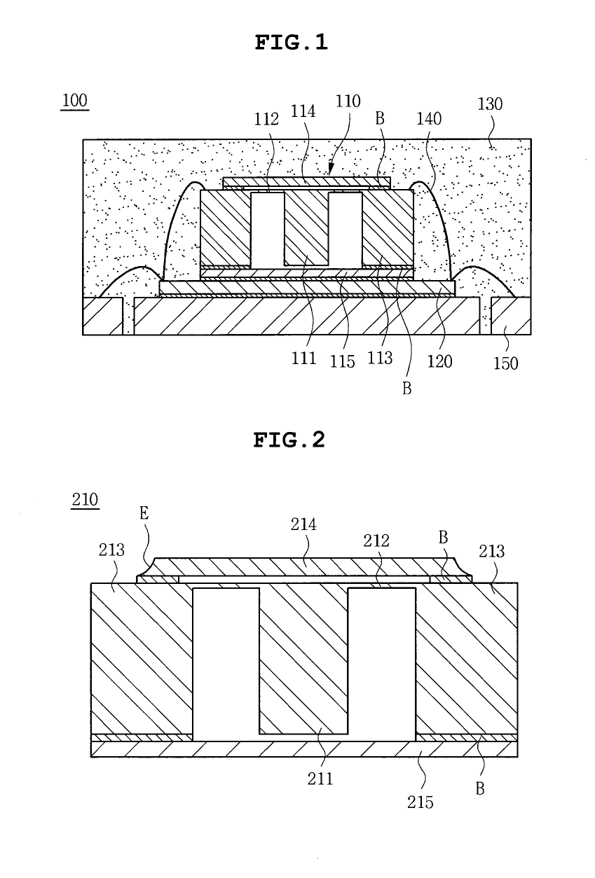

FIG. 1 is a schematic cross-sectional view of an inertial sensor according to a first preferred embodiment of the present invention. The inertial sensor according to the present invention includes a sensing unit including a mass mounted to be displaced on a flexible substrate part, a driving unit moving the mass, and a displacement detecting unit detecting displacement of the mass.

More specifically, an inertial sensor 100 includes a sensing unit 110, an ASIC chip 120, a molding part 130, a wire 140, and a lead frame or a flexible substrate 150.

The sensing unit 110 includes a mass 111, a flexible substrate part 112, a support 113, a top cap 114, and a bottom cap 115.

More specifically, the flexible substrate part 112 includes a flexible substrate, a piezo-electric material (PZT) and an electrode, wherein the flexible substrate is formed of silicon or silicon on insulator (SOI) substrate and a piezo-electric element and an electrode are deposited thereon to form a driving electrode and a sensing electrode. The mass 111 is positioned to be displaced downwardly to the bottom of the flexible substrate part and the mass 111 moves as voltage is applied to the driving electrode of the flexible substrate part 112.

In addition, the support 113 supports the mass 111 and the flexible substrate 112 and supports the mass so as to be freely movable, while being floated.

In addition, when the sensing unit 110 is EMC molded with epoxy, the top cap 114 and the bottom cap 115 protect the piezo-electric element, the electrode, and the mass 111 of the flexible substrate part, respectively. The top cap 114 and the bottom cap 115 may be made of silicon, which is the same material as that of the mass 111 and the support 113, or be made of Pyrex glass having a similar thermal expansion coefficient therewith. However, the top cap 114 and the bottom cap 115 may preferably be made of silicon, which is the same material, in consideration of workability and processability.

The top cap 114 and the bottom cap 115 may be formed to have a thickness of 100 to 200 μm. This is determined by considering the extent that the top cap 114 and the bottom cap 115 may be machined and handled. More specifically, when the top cap 114 and the bottom cap 115 are implemented to have a 4-inch substrate, they may preferably be formed to have a thickness of about 100 μm, when the top cap 114 and the bottom cap 115 are implemented to have a 6 to 8-inch substrate, they may preferably be formed to have a thickness of about 120 to 150 μm, and when the top cap 114 and the bottom cap 115 are implemented to have a 12-inch substrate, they may preferably be formed to have a thickness of about 150 to 200 μm. To this end, the top cap 114 and the bottom cap 115 may be formed by bonding a thin film-type capping substrate to the flexible substrate part 112 and the support 113, respectively, and alternatively, by bonding a thick capping substrate to the flexible substrate part 112 and the support 113, respectively and then thinly polishing them.

Both the two methods described above may be performed. However, as the mass 111 is supported by the thin film-type flexible substrate part 112, the thin film-type flexible substrate part may be broken when the top cap and the bottom cap are bonded to the flexible substrate part and the support and then the entirety thereof is polished. If the polishing process is limited in order to lower the risk of breakage, it leads to decrease in production. Therefore, it is preferable that the top cap and the bottom cap are formed by thinning the packing substrate and then bonding it to the flexible substrate part 112 and the support 113, respectively.

In addition, when bonding the top cap 114 and the bottom cap 115 to the flexible substrate part 112 and the support 113, respectively, it is preferable that the bonding area of the top cap is different from that of the bottom cap.

In addition, it is preferable that the top cap 114 and the bottom cap 115 are each bonded to the flexible substrate part 112 and the support 113 by a wafer level bonding in consideration of processability and economic feature, and the bonding thereof is performed at a low temperature of 300° C. or less in order to maintain the characteristics of the piezo-electric thin film element. More preferably, the top cap 114 and the bottom cap 115 are bonded by polymer bonding using photoresist or epoxy and thus, a bonding part B is formed.

In addition, in order that the inertial sensor according to the present invention is applied to a portable terminal, a thickness of the sensing unit 110 should be small. To this end, the sensing unit 110 may preferably be formed to have a thickness of 1.0 mm or less. In addition, the sensing unit 110 may preferably be disposed to be stacked on the ASIC chip 120.

In order to package the inertial sensor according to the present invention configured as described above in a micro-size, a Quad Flat No-Lead (QFN) package method or a Land Grid Array (LGA) package method is used. To this end, the ASIC chip 120 and the sensing unit 110 are stacked on the lead frame or the flexible substrate 150.

In addition, the sensing unit 110 according to the first preferred embodiment of the present invention is required to selectively remove a portion of the top cap 114 in order to expose a wire bonding pad, and a dry etching process may preferably be used therefor. In addition, an oxide film, which is to be used as a mask at the time of dry etching, is formed on the top cap before bonding the sensing unit, and the silicon portion of the top cap is etched using thereof. In addition, the etching is automatically stopped by the oxide film present in the bottom of the top cap and thus is able to manufacture a product having uniform quality. In addition, the oxide film is etched again by dry etching to expose the wire bonding pad, thereby wire 140 bonding the sensing unit 110 to the ASIC chip 120, the ASIC chip 120 to the lead frame or the flexible substrate 150, respectively, and then EMC molding them.

In addition, when the ASIC chip 120 is formed to be larger by 500 μm than the sensing unit 110 in a longitudinal direction, the ASIC chip 120 becomes large by 250 μm in one direction. In this case, a short wire bonding fixing with a high-step should be performed in order to improve processability at the time of wire bonding.

FIG. 2 is a schematic cross-sectional view of a sensing unit of an inertial sensor according to a second preferred embodiment of the present invention. As shown in FIG. 2, a sensing unit 210 of the inertial sensor includes a mass 211, a flexible substrate part 212, a support 213, a top cap 214, and a bottom cap 215.

The top cap 214 is subjected to an anisotropic dry etching process, using fluorine or chlorine or the like to have an etching part E, which is formed by deforming the shape of the top edge portions thereof. The etching part E prevents space utilization of a capillary tool from being lowered due to mechanical interference with the top cap at the time of wire bonding.

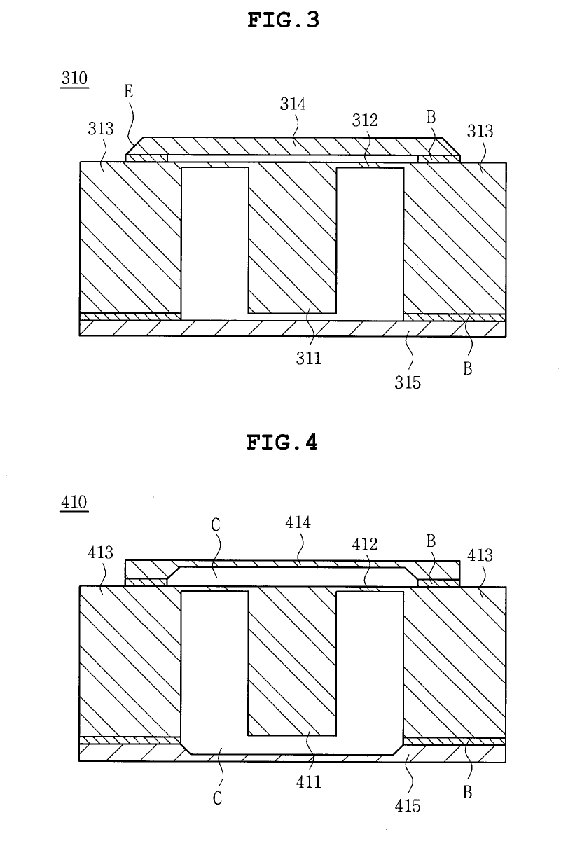

FIG. 3 is a schematic cross-sectional view of a sensing unit of an inertial sensor according to a third preferred embodiment of the present invention. As shown in FIG. 3, a sensing unit 310 of the inertial sensor includes a mass 311, a flexible substrate part 312, a support 313, a top cap 314, and a bottom cap 315.

The top cap 314 is subjected to an anisotropic wet etching process using a solution such as TMAH, KOH or the like to have an etching part E, which is formed by deforming the shape of the top edge portions thereof.

FIG. 4 is a schematic cross-sectional view of a sensing unit of an inertial sensor according to a fourth preferred embodiment of the present invention. As shown in FIG. 4, a sensing unit 410 of the inertial sensor includes a mass 411, a flexible substrate part 412, a support 413, a top cap 414, and a bottom cap 415.

The top cap 414 and the bottom cap 415 have a cavity C formed therein in order to improve the characteristics of an element. The driving characteristics of the mass 414 is affected by a size of the cavity, that is, a distance between the flexible substrate part 412 and the top cap 414, and a distance between the mass 411 and the bottom cap 415.

More specifically, the volume of the cavity is very important. In other words, when the volume of the cavity is small, the driving characteristics are affected thereby due to damping effects. When a high Q value is required, it is preferable that the interval between the micro mass and the top cap and the bottom cap is increased. In addition, when a rapid high-speed driving is required, it is preferable that the interval between the micro mass and the capping substrate is decreased.

A height of the cavity, that is a distance between the flexible substrate 412 and the top cap 414, and a distance between the mass 411 and the bottom cap 415, may preferably be 20 to 100 μm.

In addition, the cavity C may be formed by being subjected to a dry etching process or a wet etching process. In addition, the distance between the mass 411 and the top cap 414 and the bottom cap 415 may be secured only with a thickness of a bonding material B without machining the cap. However, in this case, the thickness of the sensing unit 410 may be thick. Therefore, in order to reduce the size of the sensing unit 410, it is preferable that the cavity C is formed in the top cap 414 and the bottom cap 415, respectively.

According to the present invention, the inertial sensor includes the top cap and the bottom cap covering the mass and the piezo-electric element to be implemented in an economic EMC molding package shape, while protecting the mass and the piezo-electric element. Further, the inertial sensor optimizes a thickness of the cap covering the mass and the piezo-electric element and an interval between the mass and the piezo-electric element to have improved freedom in design of utilizing space as well as improved driving characteristics and Q values.

Although the preferred embodiments of the present invention have been disclosed for illustrative purposes, they are for specifically explaining the present invention and thus an inertial sensor according to the present invention is not limited thereto, but those skilled in the art will appreciate that various modifications, additions and substitutions are possible, without departing from the scope and spirit of the invention as disclosed in the accompanying claims.

Accordingly, such modifications, additions and substitutions should also be understood to fall within the scope of the present invention.

What is claimed is:

1. An inertial sensor which includes a sensing unit including a mass mounted to be displaced on a flexible substrate part, a driving unit moving the mass, and a displacement detecting unit detecting a displacement of the mass, the inertial sensor comprising:
a top cap covering a top of the flexible substrate part; and
a bottom cap covering a bottom of the mass.

2. The inertial sensor as set forth in claim 1, wherein the top cap and the bottom cap have a thickness of 100 to 200 μm, respectively.

3. The inertial sensor as set forth in claim 1, wherein when the top cap and the bottom cap are each formed of a 4-inch substrate, they have a thickness of 100 μm, when the top cap and the bottom cap are each formed of a 6 to 8-inch substrate, they have a thickness of 120 to 150 μm, and when the top cap and the bottom cap are each formed of a 12-inch substrate, they have a thickness of 150 to 200 μm.

4. The inertial sensor as set forth in claim 1, wherein the top cap has an etching part formed at an edge portion thereof, the etching part being subjected to an anisotropic dry etching process using fluorine or chlorine.

5. The inertial sensor as set forth in claim 1, wherein the top cap has an etching part formed at an edge portion thereof, the etching part being subjected to an anisotropic wet etching process using TMAH or KOH.

6. The inertial sensor as set forth in claim 1, wherein the top cap and the bottom cap are made of silicon or Pyrex glass.

7. The inertial sensor as set forth in claim 1, wherein the sensing unit further includes a support supporting the flexible substrate part and the mass.

8. The inertial sensor as set forth in claim 7, wherein the top cap and the bottom cap are thinned and then are bonded to a top of the flexible substrate part and a bottom of the support, respectively.

9. The inertial sensor as set forth in claim 8, wherein a cavity is formed between the top cap and the flexible substrate part and between a mass and the bottom cap, respectively.

10. The inertial sensor as set forth in claim 9, wherein the cavity has a height of 20 to 100 μm.

11. The inertial sensor as set forth in claim 8, wherein the top cap and the bottom cap are each bonded to the top of the flexible substrate part and the bottom of the support by wafer level bonding or bonding using adhesive.

12. The inertial sensor as set forth in claim 1, further comprising:
an ASIC chip coupled to the bottom of the sensing unit;
a lead frame or a flexible substrate coupled to the bottom of the ASIC chip; and
a wire connecting between the sensing unit and the ASIC chip and between the ASIC chip and the lead frame or the flexible substrate, respectively.
